(19) United States
(12) Patent Application Publication
(10) Pub. No.: US 2022/0227134 A1
(43) Pub. Date: Jul. 21, 2022

(54) INKJET HEAD, METHOD FOR MANUFACTURING SAME, AND IMAGE FORMATION DEVICE

(71) Applicant: Konica Minolta, Inc., Tokyo (JP)

(72) Inventor: Hideyuki EGUCHI, Hachioji-shi, Tokyo (JP)

(21) Appl. No.: 17/614,773

(22) PCT Filed: May 30, 2019
(86) PCT No.: PCT/JP2019/021547

§ 371 Date: Nov. 29, 2021

(51) Int. Cl. B41J 2/14; B41J 2/16

(52) U.S. Cl. CPC B41J 2/14233; B41J 2/1623; B41J 2/1632; B41J 2/1646; B41J 2002/14491; B41J 2/1631; B41J 2/161; B41J 2002/14475; B41J 2002/14266; B41J 2/1643

(57) ABSTRACT

The present invention may provide an inkjet head including a pressure chamber in which an aspect ratio of a partition wall is higher, the inkjet head less likely to be broken at the time of fabrication. An inkjet head of the present invention may include a diaphragm that vibrates by actuation of a piezoelectric body, and a pressure chamber a volume of which fluctuates by vibration of the diaphragm. In the pressure chamber, a region in contact with the diaphragm is divided from an adjacent pressure chamber or flow path by a partition wall formed of metal, and the partition wall has an aspect ratio of 1.3 or higher.

### TECHNICAL FIELD

The present invention relates to an inkjet head, a method for manufacturing the same, and an image formation device.

### BACKGROUND ART

As an inkjet head used in an inkjet printer and the like, an inkjet head provided with a pressure chamber a volume of which fluctuates by actuation of a piezoelectric body and provided with an ink flow path communicating from an ink chamber to a nozzle opening via the pressure chamber is known.

Patent Literature 1 discloses a method for manufacturing the above-described inkjet head by fabricating a piezoelectric body on one surface of a diaphragm, fabricating a pressure chamber member formed of a partition wall that divides a plurality of pressure chambers on the other surface of the diaphragm, and thereafter adhering the above-described partition wall of the above-described pressure chamber member to an ink flow path member and a nozzle plate. Note that Patent Literature 1 discloses that, by forming a resist pattern of a photoresist on the other surface described above of the diaphragm and thereafter fabricating the pressure chamber member (partition wall) by electroplating, the piezoelectric body and the pressure chamber member may be integrally fabricated on both surfaces of the diaphragm, so that alignment between the piezoelectric body and the pressure chamber is facilitated.

### CITATION LIST

### Patent Literature

Patent Literature 1: JP 2009-045871 A

### SUMMARY OF INVENTION

### Technical Problem

In order to cause sufficiently large volume fluctuation for discharging ink in a pressure chamber, it is desirable that a volume of the pressure chamber itself be sufficiently large. Therefore, when the pressure chambers are to be arranged at a higher density in order to enable high-definition pattern formation, it is required to secure the volume of the pressure chamber a width of which is narrowed due to high-density arrangement by increasing a height of the pressure chamber. In order to increase the height of the pressure chamber, it is required to increase a height of a partition wall, and for this purpose, it is required to increase an aspect ratio of the partition wall (ratio (t/W) of the height (t) of the partition wall to the width (W) of the partition wall). In contrast, in order to increase the width of the pressure chamber to decrease the height of the partition wall, it is required to form an ink flow path between the pressure chambers, and the width of the partition wall becomes thinner, so that the aspect ratio of the partition wall also needs to be increased.

Such partition wall with the high aspect ratio has been conventionally fabricated by a method for performing photolithography and performing deep etching (Deep-DIE) on a support layer of a silicon on insulator (SOI) substrate, a method for performing wet etching on the support layer of the SOI substrate having an active layer plane orientation of (110) and the like. However, Si being a single crystal in which a fracture easily proceeds along a cleavage surface when a bending stress is concentrated on a defect portion is very fragile and easily broken. Especially, when forming a diaphragm to be thinner to improve compliance of the diaphragm in order to secure a volume discharging performance of the pressure chamber while arranging the pressure chambers at a high density and the like, it is required to etch the support layer deeper, and to perform processing so that a remaining thickness of the support layer becomes thinner. In a silicon wafer, generally, a wafer end is subjected to beveling processing to suppress stress concentration on a defect portion; however, when the support layer is made thinner, there is a case where breakage cannot be sufficiently suppressed even by beveling. Therefore, when fabricating the partition wall having a high aspect ratio by a conventional method, breakage is likely to occur during manufacture, and production efficiency is unlikely to be improved.

In contrast, as disclosed in Patent Document 1, it is possible to fabricate a partition wall without a cleavage surface when fabricating the partition wall on a surface of a substrate such as Si by electroplating of nickel (Ni) and the like using a resist pattern of a photoresist, so that the breakage due to a bending stress and the like is less likely to occur. However, the aspect ratio of the pattern that may be formed of the photoresist is limited to about 1/1, and it is difficult to fabricate the partition wall having the aspect ratio higher than this.

The present invention has been achieved on the basis of the above-described findings, and an object thereof is to provide an inkjet head including a pressure chamber in which an aspect ratio of a partition wall is higher, the inkjet head less likely to be broken at the time of fabrication, a method for manufacturing the same, and an image formation device provided with the inkjet head.

### Solution to Problem

The above-described problem is solved by an inkjet head including a diaphragm that vibrates by actuation of a piezoelectric body, and a pressure chamber a volume of which fluctuates by vibration of the diaphragm, in which the pressure chamber is divided from an adjacent pressure chamber or flow path by a partition wall in which a region in contact with the diaphragm is formed of metal, and the partition wall has an aspect ratio of 1.3 or higher.

The above-described problem is solved by an image formation device including the above-described inkjet head.

### Advantageous Effects of Invention

According to the present invention, provided is an inkjet head including a pressure chamber in which an aspect ratio of a partition wall is higher, the inkjet head less likely to be broken at the time of fabrication, a method for manufacturing the same, and an image formation device provided with the inkjet head.

### BRIEF DESCRIPTION OF DRAWINGS

FIG. 1 is a schematic diagram illustrating a configuration of an inkjet image formation device.

FIG. 2 is an exploded perspective view illustrating an outline of an inkjet head in a first embodiment of the present invention used in the image formation device illustrated in FIG. 1.

FIG. 3 is a cross-sectional view taken along line A-A in FIG. 2 illustrating an outline of a head chip included in the inkjet head of the first embodiment of the present invention.

FIG. 4 is a cross-sectional view taken along line B-B in FIG. 2 illustrating the outline of the head chip included in the inkjet head of the first embodiment of the present invention.

FIG. 5 is a conceptual diagram illustrating an interval (P) between adjacent pressure chambers, a width (W) of a partition wall, and a height (t) of the partition wall regarding the inkjet head in the first embodiment of the present invention.

FIG. 6A to FIG. 6C are a first flowchart illustrating steps of manufacturing the inkjet head in the first embodiment of the present invention.

FIG. 7A to FIG. 7D are a second flowchart illustrating steps of manufacturing the inkjet head in the first embodiment of the present invention.

FIG. 8A to FIG. 8D are a third flowchart illustrating steps of manufacturing the inkjet head in the first embodiment of the present invention.

FIG. 9 is a cross-sectional view taken along line B-B in FIG. 2 illustrating an outline of a head chip included in an inkjet head of a second embodiment of the present invention.

FIG. 10A to FIG. 10C are a first flowchart illustrating steps of manufacturing the inkjet head in the second embodiment of the present invention.

FIG. 11A to FIG. 11E are a second flowchart illustrating steps of manufacturing the inkjet head in the second embodiment of the present invention.

FIG. 12A to FIG. 12C are a third flowchart illustrating steps of manufacturing the inkjet head in the second embodiment of the present invention.

### DESCRIPTION OF EMBODIMENTS

Embodiments of the present invention are hereinafter described in detail with reference to the drawings. Note that a member common in the respective drawings is assigned with the same reference sign. The present invention is not limited to the following embodiments.

### First Embodiment

(Image Formation Device and Inkjet Head)

An image formation device according to a first embodiment of the present invention may be configured similarly to a well-known inkjet image formation device except that this includes an inkjet head according to this embodiment to be described later.

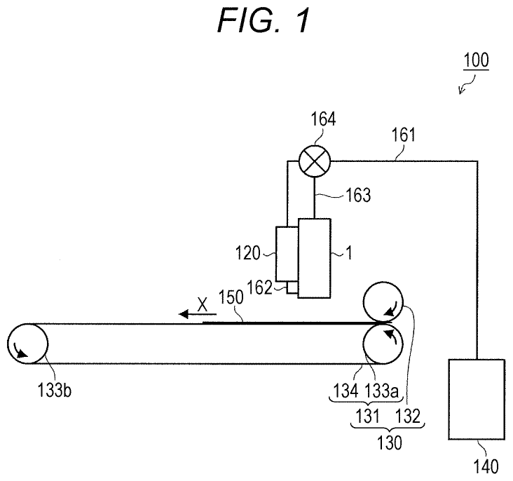

As illustrated in FIG. 1, an image formation device 100 includes an inkjet head 1, an ink supply device 120, a conveyance device 130, and a main tank 140.

The inkjet head 1 includes a plurality of nozzles for discharging ink droplets onto a recording medium 150 such as paper being a printed matter. For example, the inkjet head 1 is configured so that a plurality of types of ink of different colors are supplied to specific nozzles, respectively. The inkjet head 1 is arranged so as to be scannable in a direction crossing a conveyance direction X of the recording medium 150 on which an image should be formed, for example. A configuration of the inkjet head 1 is described later.

The conveyance device 130 is a device for conveying the recording medium 150 with respect to the inkjet head 1. The conveyance device 130 is provided with, for example, a belt conveyor 131 and a rotatable feed roller 132. The belt conveyor 131 is formed of rotatable pulleys 133a and 133b and an endless belt 134 stretched around the pulleys 133a and 133b. The feed roller 132 is arranged in a position facing the pulley 133a on an upstream side in the conveyance direction X of the recording medium 150 so as to interpose the belt 134 and the recording medium 150 between the same and the pulley 133a to feed the recording medium 150 onto the belt 134.

The ink supply device 120 is integrally arranged with the inkjet head 1. The ink supply device 120 is arranged for each type of ink. For example, when using the inks of four colors of yellow (Y), magenta (M), cyan (C), and black (K), four ink supply devices 120 are arranged on the inkjet head 1.

Each ink supply device 120 is supplied with the ink in the main tank 140 via a pipe 161 and a valve 164 connected to the main tank 140. Each ink supply device 120 is communicated with a common ink chamber 2 to be described later of the inkjet head 1 via a pipe 162, and is connected so that the ink of each color may be supplied to an ink supply port 2a of a desired common ink chamber 2.

The inkjet head 1 is also connected to the main tank 140 by a bypass pipe 163 branching from the above-described pipe 161. At a branching point between the pipe 161 and the bypass pipe 163, the valve 164 capable of switching and setting an ink flow path to one of or both the pipe 161 and the bypass pipe 163 is arranged. Each of the pipe 161, the pipe 162, and the bypass pipe 163 is, for example, a flexible pipe. The valve 164 is, for example, a three-way valve.

The main tank 140 is a tank for accommodating the ink that should be supplied to the inkjet head 1. The main tank 140 is arranged separately from the inkjet head 1. The main tank 140 includes, for example, a stirring device not illustrated. The main tank 140 may be appropriately determined according to an image forming performance, a size and the like of the image formation device 100. For example, in a case where an image forming speed of the image formation device is 1 to 3 m²/min, a capacity of the main tank 140 is, for example, 1 L.

FIG. 2 is an exploded perspective view illustrating an outline of the inkjet head 1 used in the image formation device 100 described above. As illustrated in FIG. 2, the inkjet head 1 includes the common ink chamber 2, a holder 3, a head chip 4, and a flexible wiring board 5.

The common ink chamber 2 is formed into a hollow substantially rectangular parallelepiped shape with one surface facing the holder 3 opened. The ink supply port 2a for supplying the ink of the ink supply device 120 and an ink discharge port 2b for discharging the ink to the ink supply device 120 are provided on one surface opposed to the above-described opening of the common ink chamber 2. The common ink chamber 2 is provided with a filter therein, removes foreign matters from the ink supplied from the ink supply port 2a, and finely crushes bubbles contained in the ink by the above-described filter.

The holder 3 is formed into a substantially flat plate shape with an opening 3a at substantially the center, and is arranged so as to cover the above-described opening of the common ink chamber 2. As a result, the common ink chamber 2 is connected to one surface of the holder 3 so as to cover the opening 3a. The head chip 4 is connected to the other surface of the holder 3 so as to cover the opening 3a. The holder 3 allows the common ink chamber 2 and the head chip 4 to be communicated with each other via the opening 3a.

An insertion hole 3b is provided on an outer periphery of the holder 3. The flexible wiring board 5 is inserted through the insertion hole 3b. One end of the flexible wiring board 5 is connected to a wiring board 50 of the head chip 4 to be described later. The other end of the flexible wiring board 5 is inserted through the insertion hole 3b provided on the holder 3 from the other surface of the holder 3 to be pulled out toward the common ink chamber 2.

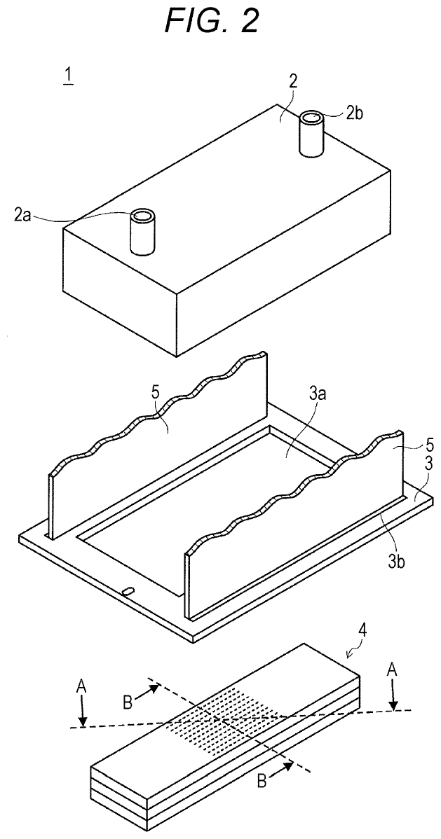

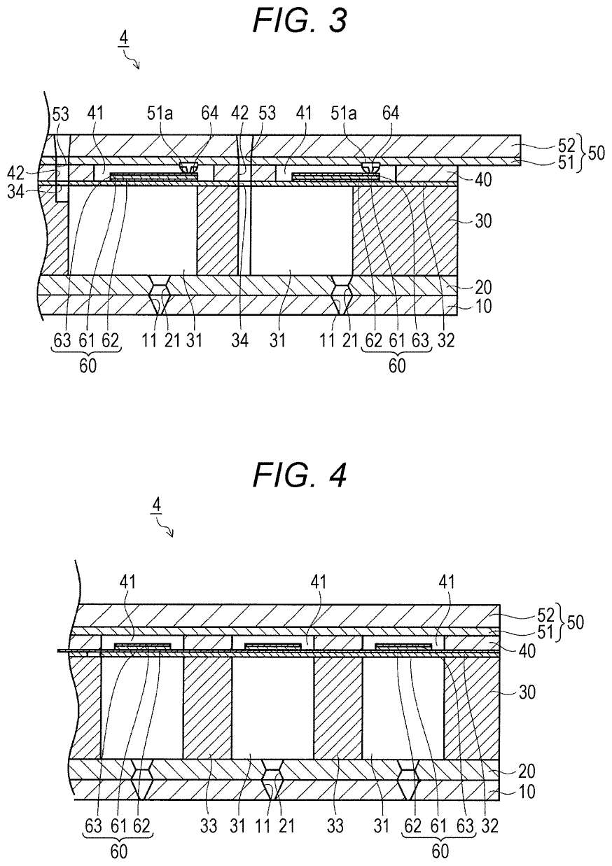

FIG. 3 is a cross-sectional view taken along line A-A in FIG. 2 illustrating an outline of the head chip 4 included in the inkjet head 1 described above, and FIG. 4 is a cross-sectional view taken along line B-B in FIG. 2 illustrating the outline of the head chip 4 included in the inkjet head 1 described above.

The head chip 4 includes a nozzle plate 10, an intermediate plate 20, a pressure chamber forming plate 30, a drive plate 40, and the wiring board 50. The head chip 4 is obtained by stacking the nozzle plate 10, the intermediate plate 20, the pressure chamber forming plate 30, the drive plate 40, and the wiring board 50 in this order from an ink discharge surface side.

A plurality of nozzle holes 11 is formed in the nozzle plate 10. The nozzle hole 11 penetrates from one surface to the other surface of the nozzle plate 10. The nozzle hole 11 has a cross-sectional shape narrowed so that a tip end side thereof serving as a discharge port has a small diameter, and discharges the ink supplied from the common ink chamber 2 from the discharge port to the outside. A plurality of (for example, 500 to 2000) nozzle holes 11 is provided in the nozzle plate 10 to be arranged in a matrix pattern. The nozzle holes 11 are communicated with a pressure chamber 31 formed in the pressure chamber forming plate 30 via the intermediate plate 20 stacked on the nozzle plate 10.

The intermediate plate 20 is arranged between the nozzle plate 10 and the pressure chamber forming plate 30. The intermediate plate 20 is provided with a first communication hole 21 that allows the nozzle hole 11 and the pressure chamber 31 provided in the pressure chamber forming plate 30 to be described later to be communicated with each other. The first communication hole 21 is provided in a position corresponding to the nozzle hole 11 of the nozzle plate 10 and penetrates from one surface to the other surface of the intermediate plate 20.

The pressure chamber forming plate 30 includes a plurality of pressure chambers 31 and a diaphragm 32. The pressure chamber 31 is provided in a position corresponding to the nozzle hole 11 of the nozzle plate 10 and the first communication hole 21 of the intermediate plate 20. The pressure chamber 31 penetrates from one surface to the other surface of the pressure chamber forming plate 30. The pressure chamber 31 applies a discharge pressure to the ink discharged from the nozzle hole 11 by volume fluctuation thereof. A partition wall 33 is formed between a plurality of pressure chambers 31. In this embodiment, an entire partition wall 33 is formed of metal capable of electroplating such as nickel (Ni). As a result, rigidity of the partition wall 33 may be improved, and the inkjet head 1 may have a stable structure that is hardly broken by vibration.

The diaphragm 32 is arranged so as to cover an opening on a side opposite to the intermediate plate 20 of the pressure chamber 31. The diaphragm 32 is provided with a second communication hole 34 communicated with the pressure chamber 31. The drive plate 40 is arranged on one surface on a side opposite to one surface on the pressure chamber 31 side of the diaphragm 32.

The drive plate 40 includes a space 41 and a third communication hole 42 communicated with the second communication hole 34. The space 41 is arranged in a position facing the pressure chamber 31 with the diaphragm 32 interposed therebetween. An actuator 60 is accommodated in the space 41.

The actuator 60 includes a piezoelectric element 61, a first electrode 62, and a second electrode 63. The first electrode 62 is stacked on one surface of the diaphragm 32. Note that an insulating layer may be arranged between the first electrode 62 and the diaphragm 32. The piezoelectric element 61 is stacked on the first electrode 62, and is arranged for each pressure chamber 31 (each channel) in a position facing the pressure chamber 31 with the diaphragm 32 and the first electrode 62 interposed therebetween.

The piezoelectric element 61 is formed of a material deformed by application of a voltage, and is formed of a ferroelectric material such as lead zirconate titanate (PZT), for example. The second electrode 63 is stacked on a surface on the side opposite to the first electrode 62 of the piezoelectric element 61. The second electrode 63 is connected to a wiring layer 51 provided on the wiring board 50 to be described later via a bump 64. A film thickness of the piezoelectric element 61 is, for example, 10 μm or less.

The wiring board 50 includes the wiring layer 51 and a silicon layer 52 on one surface of which the wiring layer 51 is formed. The wiring layer 51 is connected to the bump 64 provided on the second electrode 63 via a solder Ma. An outer edge of the wiring layer 51 is connected to the flexible wiring board 5. Furthermore, the silicon layer 52 is arranged on one surface on a side opposite to the drive plate 40 of the wiring layer 51. The silicon layer 52 is joined to the holder 3.

The wiring board 50 is provided with a fourth communication hole 53 that penetrates the wiring layer 51 and the silicon layer 52. The fourth communication hole 53 is communicated with the common ink chamber 2 via the third communication hole 42 of the drive plate 40 and the opening 3a of the holder 3.

In this embodiment, an inlet that serves as a flow path for supplying the ink in the common ink chamber 2 to the pressure chamber 31 is formed of the fourth communication hole 53 of the wiring board 50, the third communication hole 42 of the drive plate 40, and the second communication hole 34 of the diaphragm 32 communicated with one another. The inlet serves to decrease flow path resistance (flow rate) of the ink that flows from the common ink chamber 2 into the pressure chamber 31. An outlet for discharging the ink in the pressure chamber 31 toward the recording medium 150 is formed of the first communication hole 21 of the intermediate plate 20 and the nozzle hole 11 of the nozzle plate 10 communicated with each other.

In the inkjet head 1 having such a configuration, the ink accommodated in the common ink chamber 2 passes through the inlet (that is, the fourth communication hole 53, the third communication hole 42, and the second communication hole 34) and flows into the pressure chamber 31. When a voltage is applied between the first electrode 62 and the second electrode 63, the piezoelectric element 61 is actuated to be deformed (vibrates), and the diaphragm 32 is deformed (vibrates) as the piezoelectric element 61 is deformed. When the diaphragm 32 is deformed (vibrates), a pressure for discharging the ink is generated in the pressure chamber 31. Due to generation of such pressure, the ink in the pressure chamber 31 is pushed out to the outlet (that is, the first communication hole 21 and the nozzle hole 11), and is discharged from the tip end (nozzle opening) of the nozzle hole 11 toward the recording medium 150.

In the inkjet head 1 described above, in order to enable high-definition pattern formation, the pressure chambers 31 are arranged at a high density; for example, the pressure chambers 31 are arranged in a pattern of 300 dpi (an interval (P) between adjacent pressure chambers 31 is about 85 μm). At that time, in order to secure a volume of the pressure chamber 31 enabling sufficiently large volume fluctuation for discharging the ink, a width (W) of the partition wall 33 is desirably about 25 μm to 30 μm, and a height (t) of the partition wall 33 is desirably about 60 μm to 180 μm.

When the inkjet head 1 has such a configuration, a ratio of the height (t) of the partition wall to the width (W) of the partition wall is (t/W), and an aspect ratio of the partition wall is about 2.0 to 8.0.

Note that, in order to increase a width of the pressure chamber 31 and decrease the height of the partition wall 33 to suppress an increase in size of the inkjet head 1, the pressure chambers 31 may be arranged in a pattern of 75 dpi (the interval (P) between the adjacent pressure chambers 31 is about 320 μm). At that time, the height (t) of the partition wall 33 is about 50 μm to 180 μm. However, at that time, in order to form a common flow path (reservoir) of the ink between the pressure chambers 31 and arrange the pressure chambers at a higher density, the width (W) of the partition wall 33 is desirably about 25 μm.

When the inkjet head 1 has such configuration, the ratio of the height (t) of the partition wall to the width (W) of the partition wall is (t/W), and the aspect ratio of the partition wall is about 1.3 to 4.5.

In this manner, this embodiment is intended to achieve both the arrangement of the pressure chambers at a high density and securement of the volume of the pressure chamber by setting the aspect ratio of the partition wall to 1.3 or higher.

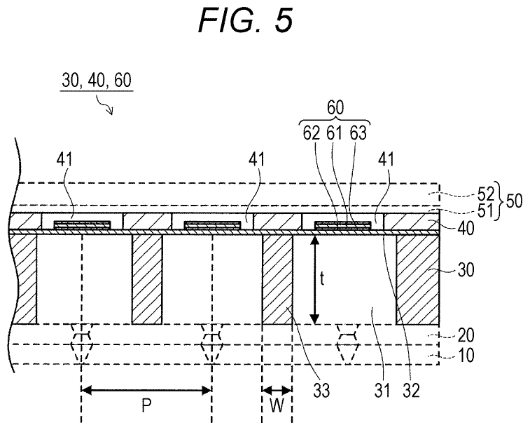

Note that, in this specification, as illustrated in FIG. 5, the interval (P) between the adjacent pressure chambers 31 means an interval between the centers of the adjacent pressure chambers 31, the width (W) of the partition wall 33 means a minimum value of a distance between one surface facing the pressure chamber of the partition wall 33 and the other surface thereof facing an adjacent space (pressure chamber or flow path) in the inkjet head 1, and the height (t) of the partition wall 33 means a length in a direction in which the discharged ink flies (in this embodiment, a distance between an end on a piezoelectric element 61 side (contact surface in contact with the diaphragm 32) and an end on an outlet side (contact surface in contact with the intermediate plate 20)) of the partition wall 33. The height (t) of the partition wall 33 is substantially equal to the length (height) of the pressure chamber 31 in the direction in which the discharged ink flies. Note that the adjacent space means, out of a plurality of pressure chambers or flow paths arranged around a certain pressure chamber, a space having a smallest distance from the center of the pressure chamber to the center thereof (pressure chamber of flow path).

(Fabrication of Inkjet Head)

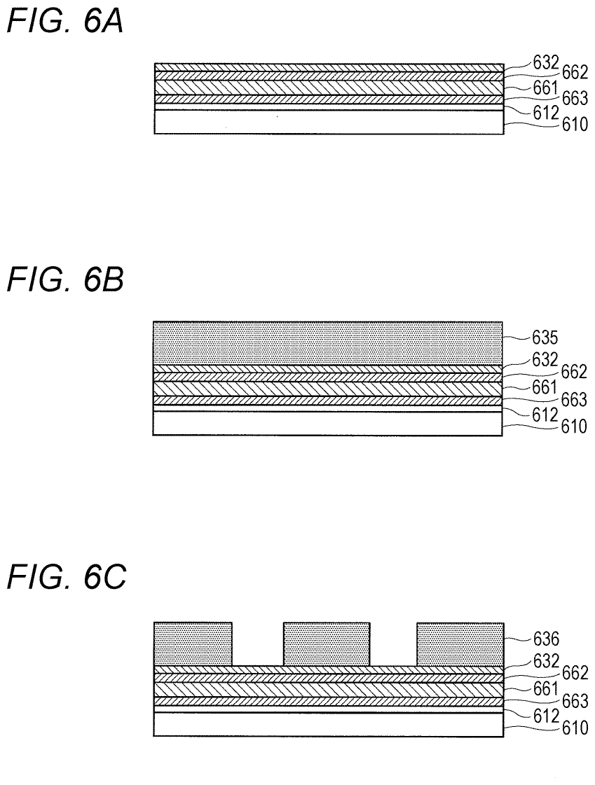

FIGS. 6A-FIG. 6C to FIG. 8A-FIG. 8D are explanatory views illustrating an example of a method for fabricating the inkjet head according to this embodiment. Note that scales of some members are changed for facilitating understanding in FIGS. 6A-FIG. 6C to FIG. 8A-FIG. 8D.

First, as illustrated in FIG. 6A, an adhesion layer 612, a second electrode layer 663, a piezoelectric layer 661, a first electrode layer 662, and a diaphragm layer 632 are formed on a substrate 610.

The substrate 610 may be a well-known substrate such as a silicon wafer, a glass substrate, a metal substrate, and a ceramic substrate.

The adhesion layer 612 is a layer for enhancing adhesion of the second electrode layer 663 to the substrate 610, and may be deposited on a surface of the substrate 610 by sputtering a target made of titanium (Ti), tantalum (Ta), iron (Fe), cobalt (Co), nickel (Ni), chromium (Cr), an alloy thereof and the like. It is sufficient that a film thickness of the adhesion layer 612 is, for example, 0.005 μm or more and 0.2 μm or less.

The second electrode layer 663 may be deposited on a surface of the adhesion layer 612 by sputtering a target made of platinum (Pt), iridium (Ir), palladium (Pd), ruthenium (Ru), an alloy thereof and the like. It is sufficient that a film thickness of the second electrode layer 663 is, for example, 0.005 μm or more and 0.2 μm or less.

The piezoelectric layer 661 may be deposited on a surface of the second electrode layer 663 by sputtering a target made of a ferroelectric material such as lead zirconate titanate (PZT), applying a sol solution containing a PZT material to the surface of the second electrode layer 663 with a spin coater and the like to gelate the same, and then burning the same. It is sufficient that a film thickness of the piezoelectric layer 661 is, for example, 1 μm or more and 10 μm or less.

The first electrode layer 662 may be deposited on a surface of the piezoelectric layer 661 by sputtering a target made of a conductive material such as platinum (Pt). It is sufficient that a film thickness of the first electrode layer 662 is, for example, 0.1 μm or more and 0.5 μm or less. Note that an insulating layer may be formed on a surface of the first electrode layer 662 by applying a photosensitive polyimide and the like and exposing the same, or sputtering a target made of an inorganic material such as SiO₂.

The diaphragm layer 632 may be deposited on the surface of the first electrode layer 662 or a surface of the insulating layer by sputtering a target made of copper (Cu), chromium (Cr), nickel (Ni), aluminum (Al), tantalum (Ta), tungsten (W), silicon (Si) and oxides and nitrides thereof. It is sufficient that a film thickness of the diaphragm layer 632 is, for example, 1 μm or more and 10 μm or less.

Thereafter, as illustrated in FIG. 6B, a first resist 635 is applied to a surface of the diaphragm layer 632. For example, a dry film resist having a film thickness of about 30 μm may be adhered to the surface of the diaphragm layer 632.

Next, as illustrated in FIG. 6C, the first resist 635 is exposed and developed to form a first resist pattern 636. The first resist pattern 636 may be formed so that a cured film having a pattern having a shape corresponding to a cross-sectional shape in a width direction (direction parallel to the diaphragm 32) of the pressure chamber to be fabricated remains on the surface of the diaphragm layer 632, and a resist having a shape corresponding to a cross-sectional shape in a width direction of the partition wall and having a shape with an aspect ratio of 1.3 or higher is removed. In this embodiment, the first resist pattern 636 is formed so that the cured film having a width of 60 μm remains on the surface of the diaphragm layer 632, and the resist having a width of 30 μm is removed in a cross-sectional view illustrated in FIG. 6C.

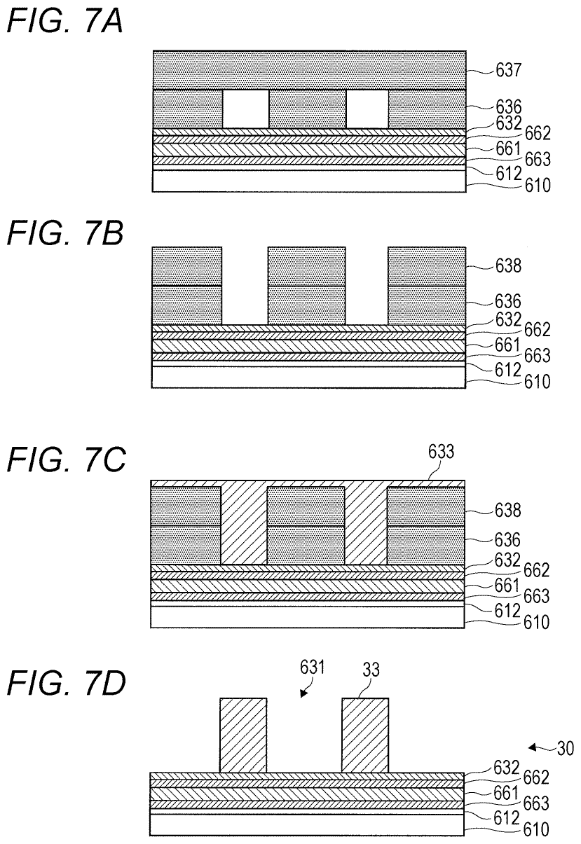

In this embodiment, thereafter, a second resist 637 is adhered to a surface of the formed first resist pattern 636 as illustrated in FIG. 7A, and this is exposed and developed to form a second resist pattern 638 as illustrated in FIG. 7B. Specifically, a dry film resist having a film thickness of about 30 μm is further adhered to the surface of the first resist pattern 636, and this is exposed and developed so that a cured film having the same shape as that of the first resist pattern 636 is formed on a surface of the cured film that forms the first resist pattern 636.

Next, as illustrated in FIG. 7C, metal 633 capable of electroplating such as nickel (Ni) is deposited by electroplating on portions from which the resist is removed of the first resist pattern 636 and the second resist pattern 638. Specifically, first, nickel sulfamate is formed in a nickel electroforming bath at a concentration of 300 to 700 g/L. The above-described electroforming bath is formed by stirring 10 to 30 g/L of boric acid and nickel chloride in pure water in advance. After pH is adjusted to about 4 and temperature is adjusted from normal temperature to about 60° C., a current of 1 to 10 A/dm² is allowed to flow through an anode in the electroforming bath, and the metal is deposited on the portion from which the resist is removed of the substrate immersed in the electroforming bath. A deposition rate increases as the temperature of a bath and current density of the anode increase. For example, in order to surely perform deposition inside the resist pattern, it is possible to adjust to suppress the deposition rate at an initial stage of deposition.

Thereafter, as illustrated in FIG. 7D, by grinding the metal 633 and the second resist pattern 638 according to the height of the partition wall 33 to be fabricated and removing the first resist pattern 636 and the second resist pattern 638, the pressure chamber forming plate 30 including the space 631 to become the pressure chamber and the partition wall 33 derived from the metal 633 is formed.

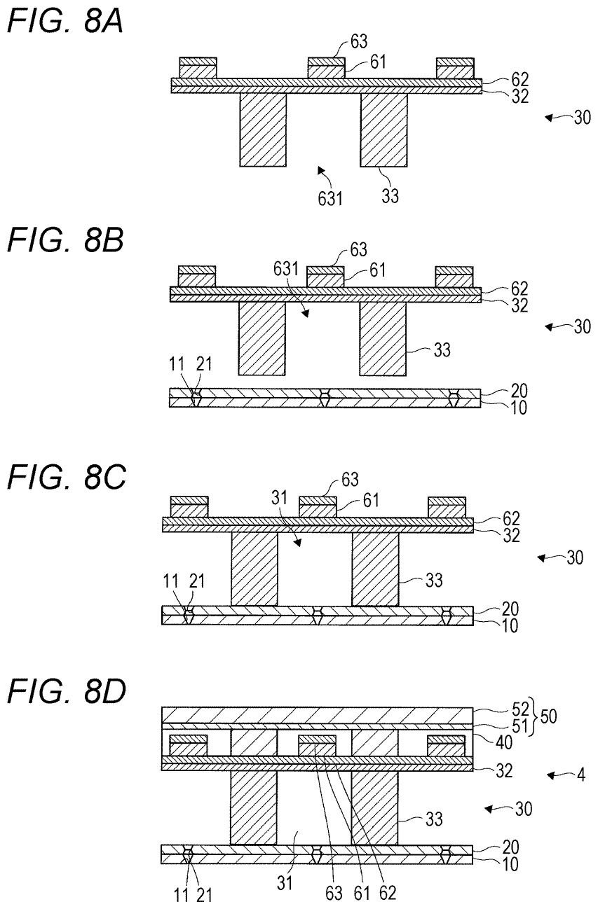

Subsequently, as illustrated in FIG. 8A (in FIG. 8A, upper and lower sides are reversed with respect to previous drawings), the substrate 610 and the adhesion layer 612 are removed by grinding, etching and the like, and the second electrode layer 663 and the piezoelectric layer 661 are individualized by a well-known method such as photolithography and etching. As a result, the piezoelectric element 61 and the second electrode 63 are formed in corresponding positions in the space 631 to become the pressure chamber. The first electrode layer 662 may be made the first electrode 62, and the diaphragm layer 632 may be made the diaphragm 32. At that time, the first electrode layer 662 may be further processed to form the ink flow path, or the diaphragm layer 632 may be further processed to further form the second communication hole 34 (not illustrated in FIG. 8A-FIG. 8D).

Next, as illustrated in FIG. 8B, the intermediate plate 20 in which the first communication hole 21 is formed and the nozzle plate 10 in which the nozzle hole 11 is formed are prepared, and the intermediate plate 20 and the nozzle plate 10 are adhered with an adhesive and the like to be joined to each other while aligning the first communication hole 21 and the nozzle hole 11. Then, as illustrated in FIG. 8C, the joined intermediate plate 20 and nozzle plate 10 described above are adhered to the partition wall 33 to be joined. As a result, the pressure chamber forming plate 30 including the pressure chamber 31 is formed.

Finally, the drive plate 40 that divides a plurality of piezoelectric elements 61 and the wiring board 50 are adhered to obtain the head chip 4. The head chip 4 thus fabricated, the flexible wiring board 5 of which is connected to the wiring board 50, is connected to the common ink chamber 2 via the holder 3 to become the inkjet head 1.

By the above-described method, the partition wall 33 having the aspect ratio of 1.3 or higher may be fabricated using the photoresist, and the inkjet head 1 including such partition wall 33 may be fabricated.

### Second Embodiment

(Image Formation Device and Inkjet Head)

An image formation device according to a second embodiment of the present invention is different from that of the first embodiment in that a partition wall 33 having an aspect ratio of 1.3 or higher included in an inkjet head 1 is formed by joining a plurality of partition wall members.

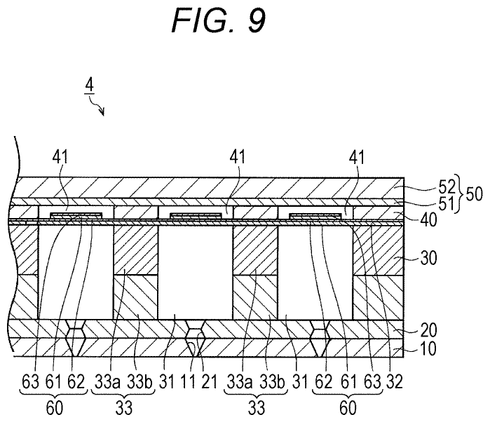

FIG. 9 is a cross-sectional view taken along line B-B in FIG. 2 illustrating an outline of a head chip 4 included in the inkjet head 1 according to this embodiment.

In this embodiment, the partition wall 33 is formed by joining a first partition wall member 33a in contact with a diaphragm 32 and a second partition wall member 33b in contact with an intermediate plate 20 to each other.

The first partition wall member 33a is made of metal capable of electroplating such as nickel (Ni) from the viewpoint of improving rigidity of the partition wall 33 to make a structure of the inkjet head less likely to be broken by vibration and stable.

The second partition wall member 33b may be formed of a material of the same type as that of the first partition wall member 33a, or may be formed of a different material. For example, the second partition wall member 33b may be formed of nickel (Ni) having high ink resistance from the viewpoint of improving durability of the inkjet head 1. In contrast, the second partition wall member 33b is preferably formed of silicon, glass, or stainless steel microfabrication of which is easy from the viewpoint of manufacturing the inkjet head 1 at a lower cost in a shorter time.

A method for joining the first partition wall member 33a and the second partition wall member 33b is not particularly limited, and they may be adhered by an adhesive or by diffusion joining between metals.

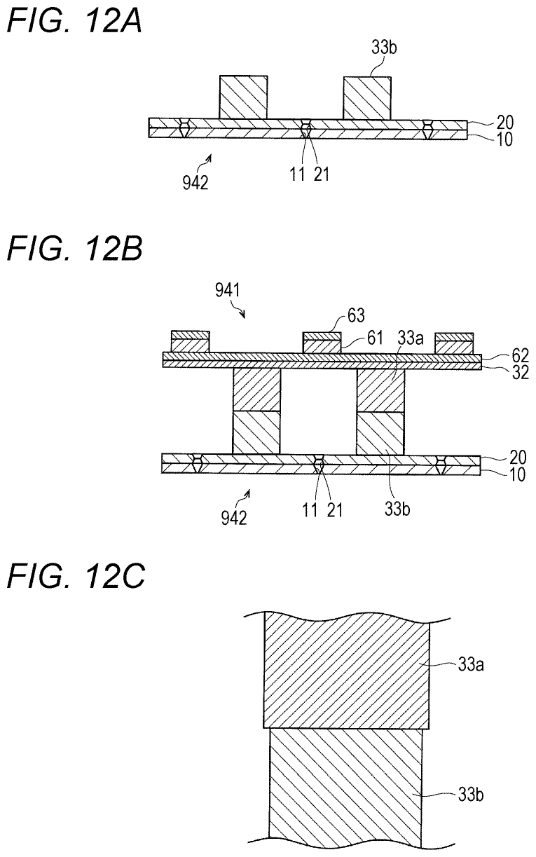

In this embodiment, the first partition wall member 33a and the second partition wall member 33b have joint surfaces of different widths (refer to FIG. 12C). As a result, as is to be described later, the joint surface having a larger width may absorb misalignment between the first partition wall member 33a and the second partition wall member 33b at the time of alignment, so that alignment when joining is easy.

(Fabrication of Inkjet Head)

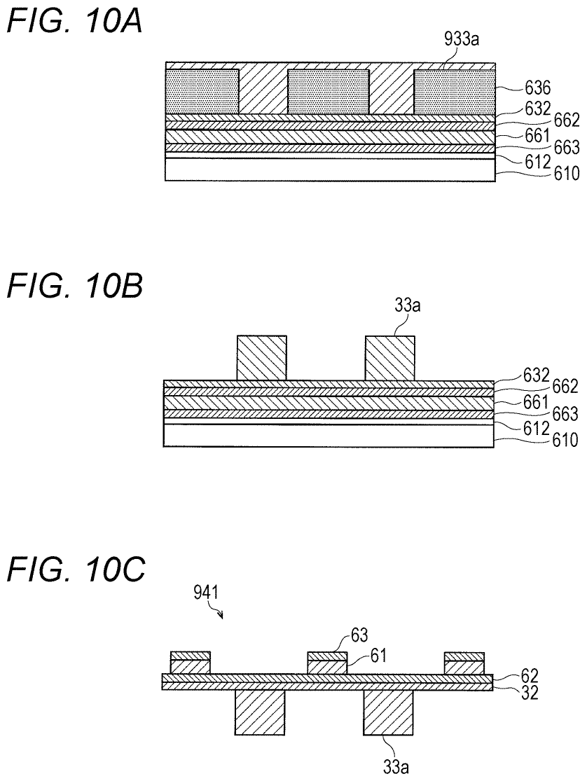

FIGS. 10A-FIG. 10C to FIG. 12A to FIG. 12C are explanatory views illustrating an example of a method for fabricating the inkjet head according to the second embodiment of the present invention. Note that scales of some members are changed for facilitating understanding in FIGS. 10A-FIG. 10C to FIG. 12A to FIG. 12C.

In this embodiment, as in the first embodiment, a first resist pattern 636 is formed on a substrate 610 on which an adhesion layer 612, a second electrode layer 663, a piezoelectric layer 661, a first electrode layer 662, and a diaphragm layer 632 are formed (refer to FIG. 6A to FIG. 6C).

Next, as illustrated in FIG. 10A, metal 933a such as nickel (Ni) is deposited by electroplating on a portion from which the resist is removed of the first resist pattern 636. Specifically, first, nickel sulfamate is formed in a nickel electroforming bath at a concentration of 300 to 700 g/L. The above-described electroforming bath is formed by stirring 10 to 30 g/L of boric acid and nickel chloride in pure water in advance. After pH is adjusted to about 4 and temperature is adjusted from normal temperature to about 60° C., a current of 1 to 10 A/dm² is allowed to flow through an anode in the electroforming bath, and the metal is deposited on the portion from which the resist is removed of the substrate immersed in the electroforming bath. A deposition rate increases as the temperature of a bath and current density of the anode increase. For example, in order to surely perform deposition inside the resist pattern, it is possible to adjust to suppress the deposition rate at an initial stage of deposition.

Thereafter, as illustrated in FIG. 10B, by grinding the metal 933a and the first resist pattern 636 and removing the first resist pattern 636, the first partition wall member 33a is formed.

Subsequently, as illustrated in FIG. 10C (in FIG. 10C, upper and lower sides are reversed with respect to previous drawings), the substrate 610 and the adhesion layer 612 are removed by grinding, etching and the like, and the second electrode layer 663 and the piezoelectric layer 661 are individualized by a well-known method such as photolithography and etching. As a result, the piezoelectric element 61 and the second electrode 63 are formed in corresponding positions in the space 631 to become the pressure chamber. The first electrode layer 662 may be made the first electrode 62, and the diaphragm layer 632 may be made the diaphragm 32. At that time, the first electrode layer 662 may be further processed to form the ink flow path, or the diaphragm layer 632 may be further processed to further form the second communication hole 34 (not illustrated in FIG. 10C).

Note that, hereinafter, a member including the first partition wall member 33a, the diaphragm 32, the first electrode 62, the piezoelectric element 61, and the second electrode 63 fabricated in this manner is also referred to as a first chip member 941.

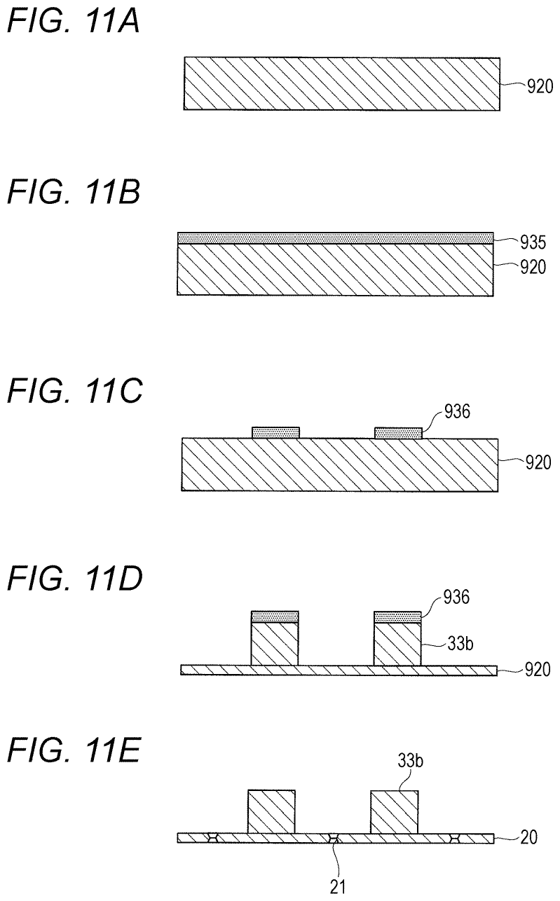

Subsequently, as illustrated in FIG. 11A, a silicon (Si) substrate 920 that becomes a material of the intermediate plate 20 is prepared.

Next, a third resist 935 is applied to one surface of the Si substrate 920 with a spin coater and the like as illustrated in FIG. 11B, and this is exposed and developed to form a third resist pattern 936 as illustrated in FIG. 11C. The third resist pattern 936 may be formed so that a cured film having a pattern having a shape corresponding to a cross-sectional shape in a width direction (direction parallel to the intermediate plate 20) of the particle wall to be fabricated remains on the surface of intermediate plate 20, and a resist having a shape corresponding to a cross-sectional shape in a width direction of the pressurization chamber is removed. In this embodiment, the third resist pattern 936 is formed so that the cured film having a width of 29 μm remains on the surface of the intermediate plate 20, and the resist having a width of 56 μm is removed in a cross-sectional view illustrated in FIG. 11B.

Next, as illustrated in FIG. 11D, the Si substrate 920 is etched using the third resist pattern 936 as a mask. The etching may be dry etching using CHF₃ (trifluoromethane) gas, CH₄ (methane) gas and the like, or may be wet etching. In this embodiment, the second partition wall member 33b having a width of 29 μm and a depth of 29 μm is formed on the Si substrate 920 by the etching.

Furthermore, as illustrated in FIG. 11E, by forming a resist pattern and etching the Si substrate 920, a first communication hole 21 that communicates a bottom of the Si substrate 920 on a side on which the second partition wall member 33b is formed with the other surface of the Si substrate 920 is formed. As a result, the intermediate plate 20 including the second partition wall member 33b is fabricated.

Subsequently, as illustrated in FIG. 12A, the nozzle plate 10 in which the nozzle hole 11 is formed is prepared, and the intermediate plate 20 and the nozzle plate 10 are adhered with an adhesive and the like to be joined to each other while aligning the first communication hole 21 and the nozzle hole 11. Note that, hereinafter, a member including the second partition wall member 33b, the intermediate plate 20, and the nozzle plate 10 fabricated in this manner is also referred to as a second chip member 942.

Next, as illustrated in FIG. 12B, the first chip member 941 (refer to FIG. 10C) and the second chip member 942 fabricated above are joined to each other while aligning the first partition wall member 33a of the first chip member 941 and the second partition wall member 33b of the second chip member 942.

FIG. 12C is an enlarged view illustrating a joint portion between the first partition wall member 33a and the second partition wall member 33b at that time. In this embodiment, the first partition wall member 33a and the second partition wall member 33b are formed so that a width on a joint surface of the first partition wall member 33a is larger than a width on a joint surface of the second partition wall member 33b. As a result, the joint surface of the first partition wall member 33a may absorb misalignment between the first partition wall member 33a and the second partition wall member 33b at the time of alignment, so that alignment when joining is easy.

Note that, in this specification, the width on the joint surface of the partition wall member means a minimum value of a distance between one side facing the pressure chamber and the other side facing the adjacent pressure chamber on the joint surface of the partition wall member.

Thereafter, the drive plate 40 that divides a plurality of piezoelectric elements 61 and the wiring board 50 are adhered and joined to form the head chip 4 as in the first embodiment. The head chip 4 thus fabricated, the flexible wiring board 5 of which is connected to the wiring board 50, is connected to the common ink chamber 2 via the holder 3 to become the inkjet head 1.

By the above-described method, the partition wall 33 having the aspect ratio of 1.3 or higher may be fabricated by joining a plurality of partition wall members, and the inkjet head 1 including such partition wall 33 may be fabricated.

Note that, although the first partition wall member 33a and the second partition wall member 33b are formed of different materials in the above-described method, but the first partition wall member 33a and the second partition wall member 33b may be formed of the same type of material. For example, the second partition wall member 33b may be formed of metal by photoresist and electroplating.

The second partition wall member 33b including a region in contact with the intermediate plate 20 may be formed not only by silicon etching but also by blast treatment on a glass substrate or diffusion joining of the second partition wall member 33b made of stainless steel and the like to the intermediate plate 20. Microfabrication of these materials is easier than the electroplating of nickel (Ni) and the like, so that the inkjet head 1 may be manufactured at a lower cost in a shorter time.

In the above-described method, the width on the joint surface of the first partition wall member 33a is made larger than the width on the joint surface of the second partition wall member 33b, but the width on the joint surface of the second partition wall member 33b may be made larger than the width on the joint surface of the first partition wall member 33a. In any case, by making the width on the joint surface of the first partition wall member 33a different from the width on the joint surface of the second partition wall member 33b, alignment when joining may be facilitated.

Note that, in this embodiment, the first partition wall member 33a in contact with the diaphragm 32 and the second partition wall member 33b in contact with the intermediate plate 20 are joined to form the partition wall 33 including the two partition wall members; however, the first partition wall member 33a and the second partition wall member 33b may be joined to each other via another partition wall member to form the partition wall 33 including three or more partition wall members.

### INDUSTRIAL APPLICABILITY

According to the inkjet head of the present invention, it is possible to achieve both the arrangement of the pressure chambers at high density and the securement of the volume of the pressure chamber. Therefore, according to the inkjet head of the present invention, it is possible to further improve definition of an image to be formed and further reduce a cost of fabricating the inkjet head, and it is expected to further contribute to spread of the inkjet head to fields such as image formation and pattern formation.

### REFERENCE SIGNS LIST

1 Inkjet head
2 Common ink chamber
2a Ink supply port
2b Ink discharge port
3 Holder
3a Opening
4 Head chip
5 Flexible wiring board
10 Nozzle plate
11 Nozzle hole
20 Intermediate plate
21 First communication hole
30 Pressure chamber forming plate
31 Pressure chamber
32 Diaphragm
33 Partition wall
33a First partition wall member
33b Second partition wall member
34 Second communication hole
40 Drive plate
41 Space
42 Third communication hole
50 Wiring board
51 Wiring layer
51a Solder
52 Silicon layer
53 Fourth communication hole
60 Actuator
61 Piezoelectric element
62 First electrode
63 Second electrode
100 Image formation device
120 Ink supply device
130 Conveyance device
131 Belt conveyor
132 Feed roller
133a, 133b Pulley
134 Belt
140 Main tank
161, 162 Pipe
163 Bypass pipe
164 Valve
610 Substrate
612 Adhesion layer
631 Space to become pressure chamber
632 Diaphragm layer
633, 933a Metal
635 First resist
636 First resist pattern
637 Second resist
638 Second resist pattern
661 Piezoelectric layer
662 First electrode layer
663 Second electrode layer
920 Silicon (Si) substrate
935 Third resist
936 Third resist pattern
941 First chip member
942 Second chip member

1. An inkjet head comprising:
a diaphragm that vibrates by actuation of a piezoelectric body; and
a pressure chamber a volume of which fluctuates by vibration of the diaphragm, wherein
the pressure chamber is divided from an adjacent pressure chamber or flow path by a partition wall in which a region in contact with the diaphragm is formed of metal, and
the partition wall has an aspect ratio of 1.3 or higher.

2. The inkjet head according to claim 1, wherein
at least a region in contact with the diaphragm of the partition wall is formed of metal containing nickel (Ni).

3. The inkjet head according to claim 1, wherein
the partition wall is formed by joining a plurality of partition wall members.

4. The inkjet head according to claim 3, wherein
joint surfaces of the plurality of partition wall members have different widths.

5. The inkjet head according to claim 3, wherein
the plurality of partition wall members includes a partition wall member formed of a material selected from a group including silicon, glass, and stainless steel.

6. A method for manufacturing an inkjet head, comprising:
forming a partition wall member in contact with a diaphragm that vibrates by actuation of a piezoelectric body by electroplating a resist pattern with metal; and
forming a pressure chamber including a partition wall having an aspect ratio of 1.3 or higher by adhering another member to the partition wall member.

7. The method for manufacturing an inkjet head according to claim 6, wherein
the resist pattern is a pattern obtained by removing a resist having a shape with an aspect ratio of 1.3 or higher from the resist adhered to a surface of the diaphragm.

8. The method for manufacturing an inkjet head according to claim 6, wherein
the other member includes a plate that forms a surface facing the diaphragm of the pressure chamber, and a partition wall member formed in contact with the plate, and
the forming the pressure chamber includes joining a plurality of partition wall members including the partition wall member included in the other member and the partition wall member in contact with the diaphragm.

9. An image formation device comprising:
the inkjet head according to claim 1.

10. The inkjet head according to claim 2, wherein
the partition wall is formed by joining a plurality of partition wall members.

11. An image formation device comprising:
the inkjet head according to claim 2.

12. An image formation device comprising:
the inkjet head according to claim 3.

13. The inkjet head according to claim 4, wherein
the plurality of partition wall members includes a partition wall member formed of a material selected from a group including silicon, glass, and stainless steel.

14. An image formation device comprising:
the inkjet head according to claim 4.

15. An image formation device comprising:
the inkjet head according to claim 5.
